(19) United States
(12) Patent Application Publication
(10) Pub. No.: US 2026/0233979 A1
(43) Pub. Date: Aug. 13, 2026

(54) WALL HOIST SYSTEMS, WALL HOISTS, AND RELATED METHODS OF USE

(71) Applicant: Gary Cloutier, Sturgeon County (CA)

(72) Inventor: Gary Cloutier, Sturgeon County (CA)

(21) Appl. No.: 19/540,386

(22) Filed: Feb. 13, 2026

(30) Foreign Application Priority Data
Feb. 13, 2025 (CA) 3264970

(51) Int. Cl. B66C 23/36; B66C 1/66; E05B 65/00

(52) U.S. Cl. CPC B66C 23/36; B66C 1/66; E05B 65/0014

(57) ABSTRACT

A wall hoist system includes: a structural body that defines a beam passage that opens laterally to define a mouth; a gate mounted to translate relative to the structural body to open and close the mouth; and an anchor mount for a release cable, with a cable guide, for mounting and directing a release cable to in use.

### TECHNICAL FIELD

This document relates to wall hoist systems, wall hoists and related methods of use.

### BACKGROUND

The following paragraphs are not an admission that anything discussed in them is prior art or part of the knowledge of persons skilled in the art.

A wall hook is used to raise a wall frame into place in a building construction project, usually using a crane or telehandler. Once in place, the wall frame is secured to a foundation or other part of the building structure frame. Wall hooks include the Model WH™ and the Model WP™ models by Rig-Master™, which are structured to release the beam via a manual procedure or a release cable that removes a pin to unlock the device.

### SUMMARY OF THE INVENTION

A wall hoist system is disclosed comprising: a structural body that defines a beam passage that opens laterally to define a mouth; a gate mounted to translate relative to the structural body to open and close the mouth; and a release cable that is connected to open the gate when the release cable is pulled downward from a position below the structural body in use.

A method is disclosed comprising: securing a wall hoist to a beam of a wall frame by inserting the beam through a mouth, and into a beam passage, of the wall hoist and securing the beam from exit from the mouth by translating a gate into a closed position; lifting the wall hoist to erect the wall frame into an upright position; and releasing the wall hoist from the wall frame by pulling on a release cable to translate the gate into an open position.

A wall hoist system is disclosed comprising: a structural body that defines a beam passage that opens laterally to define a mouth; a gate mounted to translate relative to the structural body to open and close the mouth; and an anchor mount for a release cable, with a cable guide, for mounting and directing a release cable to in use.

In various embodiments, there may be included any one or more of the following features: The wall hoist has a lift connector on the structural body. A cable guide is positioned on the structural body to redirect the release cable to the gate. The cable guide is defined by a fixed pulley or bushing mounted on the structural body. The gate extends from a slide carriage that is mounted to translate within the structural body. A portion of the release cable engages the slide carriage at a cable connection point that is below the cable guide. A lifting end of the release cable is anchored to the cable connection point on the slide carriage. The cable connection point forms a second cable guide that defines a moving pulley or bushing that redirects the release cable to a cable anchor point on the structural frame. A rear portion of the slide carriage comprises a slide post; and the structural body defines one or more slide post guides to align and guide the slide post along a translation axis of the slide carriage. A rear portion of the slide carriage comprises a slide post or a slide post guide; and the structural body comprises the other of the slide post or slide post guide to align and guide the slide carriage along a translation axis within the structural body. The lateral position of the gate is adjustable, relative to the mouth, to modify a lateral width of the beam passage when the gate is closed. The slide carriage defines a plurality of discrete gate mounting positions. The plurality of gate mounting positions include one or more of a first position that is structured to receive within the beam passage a beam of 3.5″ lateral width, and a second position that is structured to receive within the beam passage a beam of 5.5″ lateral width. The plurality of gate mounting positions include one or more of: a position that is structured to receive within the beam passage a beam of 3.5″ lateral width; a position that is structured to receive within the beam passage a beam of 5.5″ lateral width; and a position that is structured to receive within the beam passage a beam of 7.25″ lateral width. The release cable extends through one or more cable eyelets on an exterior surface of the structural body below the cable guide. The release cable extends through an interior of the structural body, via an open base of the structural body, to the cable guide; or along an exterior surface of the structural body, through one or more cable eyelets on the exterior surface of the structural body, to the cable guide. The gate is mounted to translate up to open the mouth when the release cable is pulled downward, in use. The beam passage is defined by a beam support shelf, an upright riser, and an overhead cantilever. The beam support shelf, upright riser, and overhead cantilever collectively have a C-shape. The gate comprises a removable pin. The structural body is formed by a plurality of plates welded or bent together. The device has or more magnets to one or more of hold the gate in the open or closed positions. The device further comprises one or more magnets on the structural body or the gate to one or more of hold the gate in: an open position; or a closed position. Anchoring the wall frame to a building structure or ground surface while the wall frame is in the upright position and prior to releasing the wall hoist from the wall frame. Securing further comprises translating the gate across the mouth. Lifting is carried out using a crane or telehandler that is connected to the wall hoist. The lift connector comprises a lifting lug. The wall hoist device may be structured to permit the release cable or a second release cable to close the gate.

The foregoing summary is not intended to summarize each potential embodiment or every aspect of the subject matter of the present disclosure. These and other aspects of the device and method are set out in the claims.

### BRIEF DESCRIPTION OF THE FIGURES

Embodiments will now be described with reference to the figures, in which like reference characters denote like elements, by way of example, and in which:

FIG. 1 is a perspective view of a wall hoist device with a beam receiving mouth and a gate of the beam receiving mouth in a closed position.

FIG. 2 is a perspective view of the wall hoist device of FIG. 1, with the gate in an open position.

FIG. 3 is another perspective view of the wall hoist device of FIG. 1.

FIG. 4 is a lower perspective view of the wall hoist device of FIG. 1.

FIG. 5 is an upper perspective view of the wall hoist device of FIG. 1, with a side wall of the wall hoist device removed for illustration.

FIG. 6 is a section view taken along the 6-6 section lines of FIG. 3.

FIG. 7 is a perspective view of the wall hoist device of FIG. 1, with the gate in the open position and the gate pin located in a front aperture position.

FIG. 8 is a perspective view of the wall hoist device of FIG. 1, with the gate in the closed position.

FIG. 9 is a side elevation view of the wall hoist device of FIG. 1, with the internal components of the wall hoist device illustrated in dashed lines, and the gate in the open position.

FIG. 10 is a front-end view of the wall hoist device of FIG. 1 in the open position.

FIG. 11 is a side elevation view of the wall hoist device of FIG. 1, with the internal components of the wall hoist device illustrated in dashed lines, and the gate in the open position.

FIG. 12 is a side elevation view of the wall hoist device of FIG. 1, with the internal components of the wall hoist device illustrated in dashed lines, and the gate in the closed position.

FIG. 13 is a perspective view of a slide carriage from the wall hoist device of FIG. 1.

FIG. 14 is a perspective view of another embodiment of a slide carriage for the wall hoist device of FIG. 1.

FIG. 15 is a side elevation view of the slide carriage of FIG. 14.

FIG. 16 is a top plan view of the slide carriage of FIG. 14.

FIGS. 17-20 illustrate the wall hoist device of FIG. 1 being used to lift a wall frame into a vertical, upright position.

FIG. 21 is a side elevation view, in section, of another embodiment of a wall hoist device, provided with two gate pins for illustration, and having a slide carriage mounted to translate within the structural body along a slide post.

FIG. 22 is a perspective partial cutaway view of the wall hoist device of FIG. 21, with a side wall of the wall hoist device removed.

FIG. 23 is a perspective partial cutaway view of the wall hoist device of FIG. 21, with a side wall of the wall hoist device removed.

FIG. 24 is a side elevation view of the wall hoist device of FIG. 21, with the gate in the closed position.

FIG. 25 is a side elevation view of the wall hoist device of FIG. 21, with the gate in the inside position and in an open position, and illustrating in dashed lines the position of the release cable inside the interior of the structural body, arranged to engage the slide carriage as a moving pulley or bushing to provide a twofold lifting force advantage when a user pulls the release cable downward..

FIG. 26 is a perspective view of another embodiment of a wall hoist device with the gate in an open position.

FIG. 27 is a perspective view of the wall hoist device of FIG. 26, with the gate in a closed position.

FIG. 28 is a side elevation view of the wall hoist device of FIG. 26, with the gate in the open position.

FIG. 29 is a side elevation view of the wall hoist device of FIG. 26, with the gate in a closed position, and illustrating in dashed lines the position of the release cable inside the interior of the structural body, arranged to engage the slide carriage as a moving pulley or bushing to provide a twofold lifting force advantage when a user pulls the release cable downward.

FIG. 30 is a perspective view of a slide carriage for the wall hoist device of FIG. 21.

FIG. 31 is a top plan a view of the slide carriage of FIG. 30.

FIG. 32 is a section view taken along the 32-32 section lines of FIG. 31.

FIG. 33 is a side elevation view of another embodiment of a wall hoist device with a beam receiving mouth and a gate of the beam receiving mouth in an open position.

FIG. 34 is a front-end view of the wall hoist device of FIG. 33

FIG. 35 is a perspective view of the wall hoist device of FIG. 33.

FIG. 36 is a side elevation view of the wall hoist device of FIG. 33 with the gate of the beam receiving mouth in a closed position.

FIG. 37 is a top plan view of a slide carriage of the wall hoist device of FIG. 33.

FIG. 38 is a side elevation view of the wall hoist device of FIG. 36, with the inner mechanism of the gate illustrated in a cutaway portion with the position of internal parallel slide posts and supporting structure defined within dashed lines.

### DETAILED DESCRIPTION

Immaterial modifications may be made to the embodiments described here without departing from what is covered by the claims.

Building construction is a multidisciplinary process that involves designing, planning, and assembling structures using various engineering techniques and materials. The process begins with site preparation, which includes surveying, grading, and foundation work to provide structural stability. Framing is then constructed using materials such as wood, steel, or reinforced concrete, depending on the building's design and load requirements. Structural integrity is ensured through load-bearing elements, such as beams, columns, and shear walls, which distribute forces efficiently. Mechanical, electrical, and plumbing systems are integrated to provide essential services like heating, ventilation, electrical distribution, and water supply. Advanced construction techniques, including prefabrication, modular construction, and the use of Building Information Modeling, improve efficiency, reduce material waste, and enhance coordination among stakeholders.

Framing is a critical phase in building construction that provides the structural framework supporting the entire structure. It involves assembling load-bearing and non-load-bearing components, typically using materials such as wood, steel, or reinforced concrete, depending on the project's design and structural requirements. In wood-framed buildings, dimensional lumber or engineered wood products like laminated veneer lumber and cross-laminated timber are commonly used to form walls, floors, and roof systems. Steel framing, often used in commercial and high-rise construction, consists of cold-formed or hot-rolled steel members that offer high strength and durability. The framing process includes constructing floor joists, wall studs, beams, columns, and roof trusses, ensuring proper load distribution and lateral stability. Shear walls, bracing, and fasteners enhance structural integrity and resistance to forces such as wind and earthquakes. Precise framing is essential for maintaining building alignment, supporting finishes, and integrating mechanical, electrical, and plumbing systems efficiently.

Wood beams, such as 2×4 and 2×6 lumber, serve as essential structural components in wall frame construction and erection, providing strength, stability, and load distribution in residential and commercial buildings. These beams are typically made from kiln-dried softwood species like pine or fir, ensuring dimensional stability and resistance to warping. Each beam has a longitudinal axis extending along its length, typically oriented vertically when used as studs or horizontally when used as top and bottom plates. The lateral dimensions of a standard 2×4 beam measure approximately 1.5 inches by 3.5 inches, while a 2×6 beam measures approximately 1.5 inches by 5.5 inches, accounting for planing and finishing processes. In conventional framing, 2×4 beams are positioned vertically as studs at regular intervals (typically 16 or 24 inches apart) between a bottom plate and a top plate, forming the primary framework of a wall. Larger beams, such as 2×6s, may be utilized for exterior walls to accommodate additional insulation or to support greater structural loads. The erection process involves securing these beams with nails or screws and reinforcing critical load-bearing connections using metal fasteners, brackets, or adhesive bonding techniques. During construction, plumb and level alignment of the beams is ensured using laser levels or traditional leveling tools, preventing structural misalignment that could compromise integrity. Additionally, openings for doors, windows, and utilities are framed by incorporating horizontal headers and supports, ensuring proper weight distribution. The method of securing and assembling these wood beams in wall framing is crucial to meeting building code requirements and achieving long-term structural durability.

Hoisting and securing a framed wall is a crucial step in the construction process, ensuring structural stability and alignment. The process begins with assembling the wall frame flat on the ground, incorporating studs, top and bottom plates, and any necessary openings for doors and windows. In some cases, fascia boarding is added, such as oriented strandboard or plywood. Once the wall frame is complete, it is hoisted into place using manual lifting techniques for smaller walls or mechanical equipment such as wall jacks, telehandlers, or cranes for larger, heavier sections. Proper bracing is essential during lifting and thereafter to prevent excessive movement or structural damage. Once positioned, the wall is temporarily secured using braces, typically angled 2×4s, nailed to both the framing and the floor or foundation. The wall is then checked for plumb using a level or laser alignment tool before being permanently fastened with nails, screws, or anchor bolts, depending on the material and structural requirements. Sheathing or additional bracing may be installed to enhance rigidity and lateral stability.

There are several methods for hoisting a framed wall/wall frame, depending on its size, weight, and site conditions. For smaller, lighter walls, manual lifting is the most common method, where multiple workers lift the wall from the ground into position using coordinated effort. For larger or heavier walls, mechanical assistance is often required. Wall jacks, such as crank-operated or pneumatic jacks, provide controlled lifting by attaching to the top plate and gradually raising the wall into place. Another method of lifting may involve using a forklift or telehandler, which can lift, and position prefabricated or heavy wall sections with precision. In large-scale construction projects, cranes equipped with rigging and slings are used to lift and set massive wall panels, particularly for precast concrete or steel-framed structures.

Specialized wall hoisting devices may be used in construction to safely hoist and position framed walls, with the choice depending on wall size, weight, and site conditions. A wall pick is a specialized lifting attachment that connects to the top plate of a framed wall, allowing a crane or hoist to lift it with even weight distribution, reducing the risk of structural damage or misalignment. Wall hooks are another lifting device, consisting of steel hooks or brackets that attach securely to the top plate of a framed wall, providing a stable lifting point for hoisting equipment. A release cable may be provided to unlock the wall hook when the wall frame is in place and secured. Cranes are widely used for lifting large, heavy wall panels, such as prefabricated wood, steel, or concrete walls, offering precise positioning and enhanced safety for high-rise or large-scale construction projects. Winches, whether manual or powered, provide controlled lifting and lowering of walls, commonly used in smaller construction projects or tight job sites where a crane may not be practical.

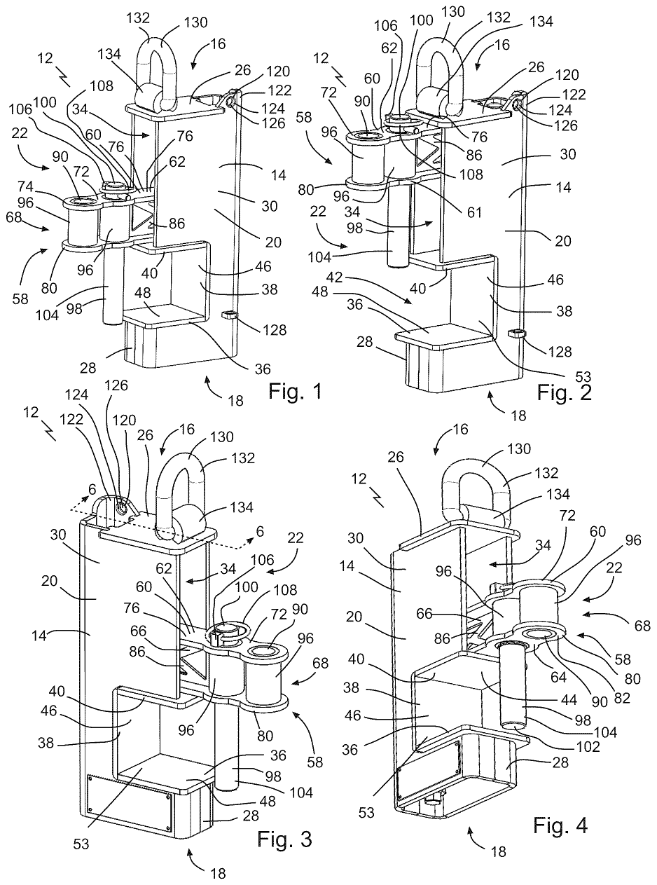

Referring to FIGS. 1-12 and 17-20, a wall hoist system 10 is disclosed. The wall hoist system 10 comprises a wall hoist device 12. The wall hoist device 12 comprises a structural body 14, which may have a top 16, a base 18, sides 20 and a front 22. The structural body 14 may define a beam passage 42. A beam passage may be shaped to receive a cross-sectional area of a wooden beam of standard lateral dimensions, while providing opposed open ends to pass the length of the beam along its longitudinal beam axis 164. The beam passage 42 opens laterally to define a mouth 54. The beam passage 42 may be defined in part by a beam support shelf 36. The wall hoist device 12 comprises a gate 98, which may be mounted to translate, for example slide up and down, relative to the structural body 14 to open and close the mouth 54 (move the gate between open and closed positions). The device 12 may define a cable guide 120 positioned on the structural body to redirect the release cable to the gate, to transfer power from the release cable to the gate or slide carriage, to permit a release cable to be, in use, connected to the gate 98. The system 10 may comprise a release cable 136 that is connected to raise the gate 98 when the release cable 136 is pulled downward from a position below the structural body 14, although the device 12 may or may not include the cable 136 when provided by a manufacturer or distributor. The wall hoist system 10 may be used to erect a wall frame 148 into a vertical position. The wall hoist device 12 may be secured to a beam 154, such as a beam forming a top plate, of the wall frame 148 by inserting the beam 154 through the mouth 54 and into the beam passage 42. The beam 154 may be secured from exiting the mouth 54 using the gate 98. Once the beam 154 is secured, the wall hoist device 10 may be lifted to erect the wall frame 148 into a vertical position. Once the wall frame 148 is in an upright, for example vertical, position, the wall hoist device 12 may be released from the wall frame 148 by pulling on the release cable 136 to slide the gate 98 up.

A wall frame that is about to be erected in a building construction project consists of several interconnected structural components designed to provide stability, load-bearing capacity, and support for exterior and interior finishes. The primary structural elements include vertical studs, typically made of dimensional lumber such as 2×4 or 2×6 beams, which form the main framework of the wall. These studs are evenly spaced, commonly at 16-inch or 24-inch intervals, and extend between a bottom plate (sole plate) and a top plate, both of which run horizontally along the length of the wall to secure the studs in place. Additional structural reinforcements include headers, which span across window and door openings to distribute loads around these voids, and cripple studs or jack studs, which provide added support beneath and above such openings. Bracing components, such as diagonal braces or sheathing panels, are incorporated to enhance lateral stability and resistance to forces such as wind or seismic activity. Fasteners, including nails, screws, or metal brackets, secure the connections between components, ensuring structural integrity. Utility accommodations, such as pre-drilled holes or notches in the studs, allow for the installation of electrical wiring, plumbing, and HVAC ducts before the application of insulation and drywall. Prior to erection, the wall frame is typically assembled flat on the floor, ensuring precise alignment of components before it is raised into position and secured to the building's foundation or structural framework. The design and construction of the wall frame must comply with local building codes and engineering requirements to ensure long-term safety and performance.

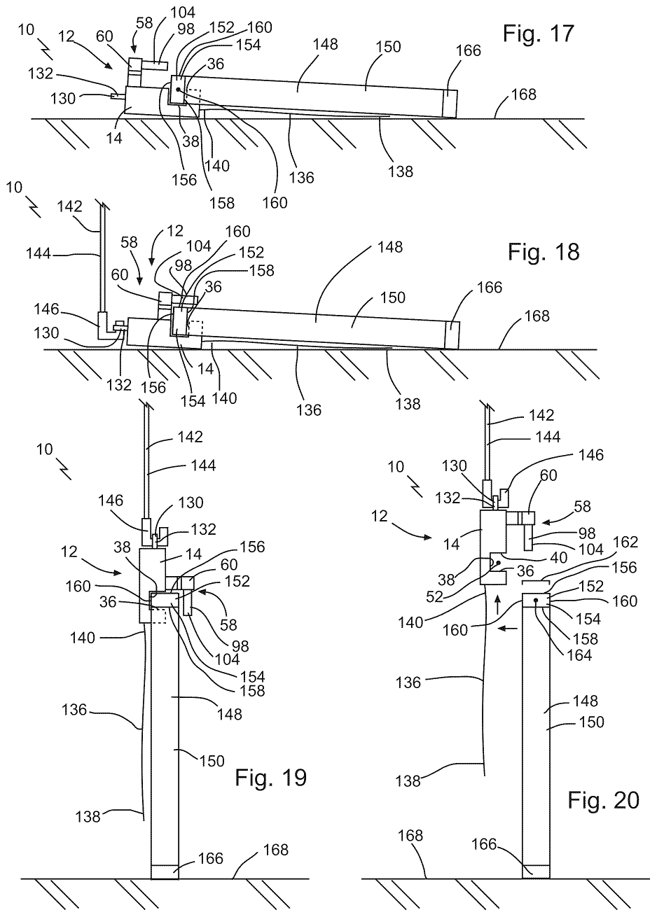

Referring to FIGS. 17-20, an example wall frame 148 is disclosed. The wall frame 148 may comprise studs 150 that are connected by a top plate 152 and a bottom plate 166, the latter of which are formed by respective wood beams. The top plate 152 may define the beam 154 that is discussed below as being received in use within the beam passage of the wall hoist. The beam 154 may define a top 156, a base 158 and lateral sides 160, with a lateral width 57 and height of the passage of the wall hoist device 12 sized to be larger than or equal to a width 162 and height of the beam 154.

Referring to FIGS. 1-12, the wall hoist device 12 may have a suitable structure. The structural body 14 may form a housing made up of a plurality of plates welded or bent together. For example, the structural body 14 may be formed by a top plate 26, base 28, side walls 30 and a rear wall 32. The side walls 30 may form an open front 34. In general, a suitable structural body or housing can be formed using various manufacturing techniques, each selected based on structural requirements, material properties, and intended application. One common method involves joining metal plates, such as steel or aluminum, by welding, bolting, or riveting to create a rigid enclosure. Welding provides a seamless, high-strength connection, while bolting or riveting allows for disassembly and modular construction. Alternatively, casting can be used to form a housing as a single integral structure by pouring molten material—such as metal, plastic, or composite resin into a mold, reducing the need for post-processing assembly and enhancing structural uniformity. Extrusion is another technique, where materials like aluminum or plastic are forced through a shaped die to create continuous-profile housings that can be cut to length. For lightweight and high-precision applications, injection molding is used to produce plastic housings by injecting molten polymer into a cavity mold, enabling intricate geometries and mass production. In applications requiring enhanced strength-to-weight ratios, composite layup techniques involve layering fiber-reinforced materials, such as carbon fiber or fiberglass, with resins, followed by curing under heat or pressure to achieve a durable and lightweight structure. Sheet metal forming, including stamping or deep drawing, is also widely used to create housings with complex contours from a single sheet, minimizing seams and improving mechanical strength. The selection of a specific housing formation method depends on factors such as required material strength, environmental resistance, production volume, and cost considerations.

Referring to FIGS. 1-12, the beam passage 42 may have a suitable structure. One or more of a beam support shelf 36, an upright riser 38 and an overhead cantilever 40 may collectively form the beam passage 42. The beam support shelf, upright riser, and overhead cantilever may collectively define a C-shape. The support shelf 36 may define an under surface 44, the upright riser may define a rear surface 46, and the support shelf 36 may define a shelf surface 48, the surfaces of which define the passage 42 and a beam-receiving internal cavity 50. In use the beam top plate 152 may be inserted along a lateral entry axis 56 of the mouth 54, into the internal cavity 50 of the beam passage 42 and at any given time during lifting, the beam may rest on one or more of the under surface 44, the rear surface 46 or the shelf surface 48. An axis 164 of the beam 154 may align with an axis 52 defined by the beam passage 42. The passage may define a longitudinal bore extending along a portion of the beam's length, defined by an interior surface that may be cylindrical, rectangular, or another geometric configuration optimized for structural efficiency. The passage may include one or more reinforcement features, such as a lining, sleeve, or resin coating, to enhance durability and prevent material degradation. Additionally, the passage may incorporate support ribs, collars, or inserts positioned at intervals along its length to distribute loads and reduce stress concentrations. The entry and exit points of the passage may be chamfered or beveled to minimize stress risers and facilitate the insertion of components.

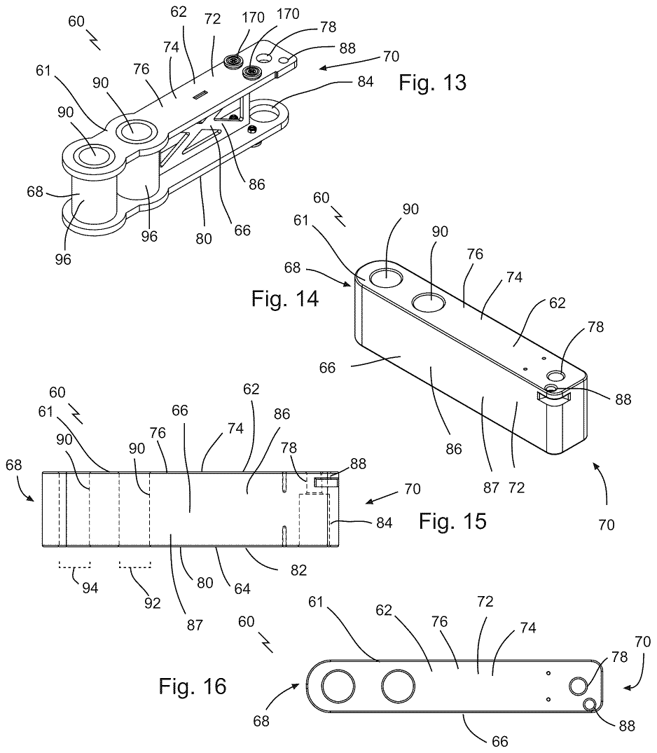

Referring to FIGS. 1-13, the gate 98 may extend from a slide carriage 60 that is mounted to translate at least partially within the structural body 14. The slide carriage 60 assembly may be mounted for translational movement within the structural body 14. A suitable gate mechanism 58 may comprise the gate 98 and a slide carriage 60. The gate 98 may depend from the slide carriage 60 in the event that the wall hoist is structured to have the gate raise and lower in use when in an upright position. The slide carriage 60 may be mounted to slide up and down, at least partially, within the structural body 14.

Referring to FIGS. 1-13, the slide carriage may comprise a carriage frame 61 configured to support a load and engage with internal guide surfaces of the structural body. The slide carriage may define a top 62, a base 64, sides 66, a front 68 and a rear 70. The carriage frame may include a base section (base 64) and opposing lateral sections (sides 66), which collectively define a structure to accommodate guide rails, tracks, or linear bearings integrated within the structural body. The carriage is operably coupled to the structural body through a bearing interface, which may include rolling elements such as ball bearings, roller bearings, or low-friction sliding surfaces to facilitate smooth motion while minimizing resistance and wear. In some embodiments, the slide carriage features a drive mechanism, such as a lead screw, belt, or actuator linkage, to control movement along a predefined path. Additionally, retention elements, such as guide blocks, retaining clips, or preload adjustment components, may be incorporated to ensure precise alignment and prevent unintended displacement. The rear 70 of the slide carriage 60 may be connected to the structural body 14, for examiner the rear 70 portion of the slide carriage may comprise a slide post 110. The slide carriage 60 frame 61 may define an arm 72. The arm 72 may comprise an upper arm 74 and a lower arm 80. The upper arm 74 and the lower arm 80 may be connected by a webbing 86.

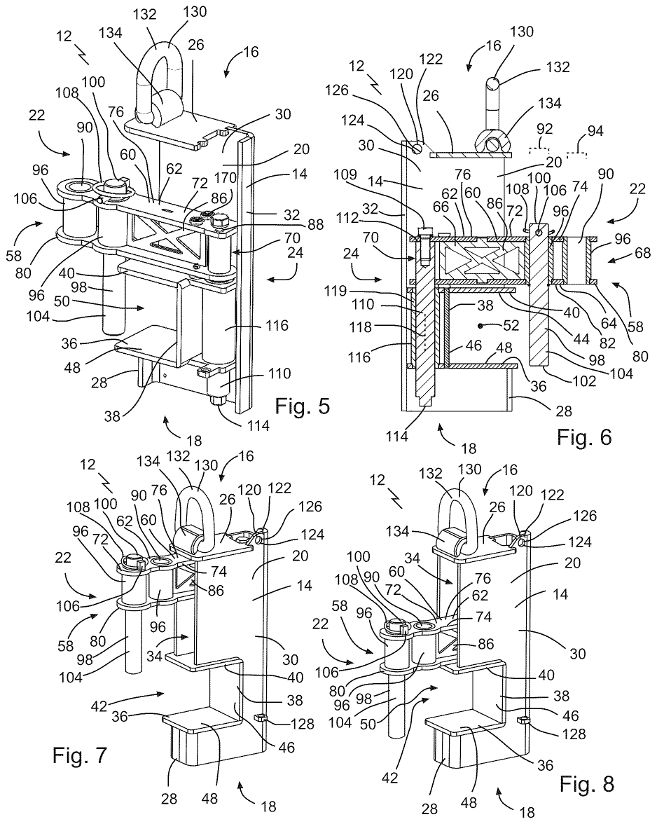

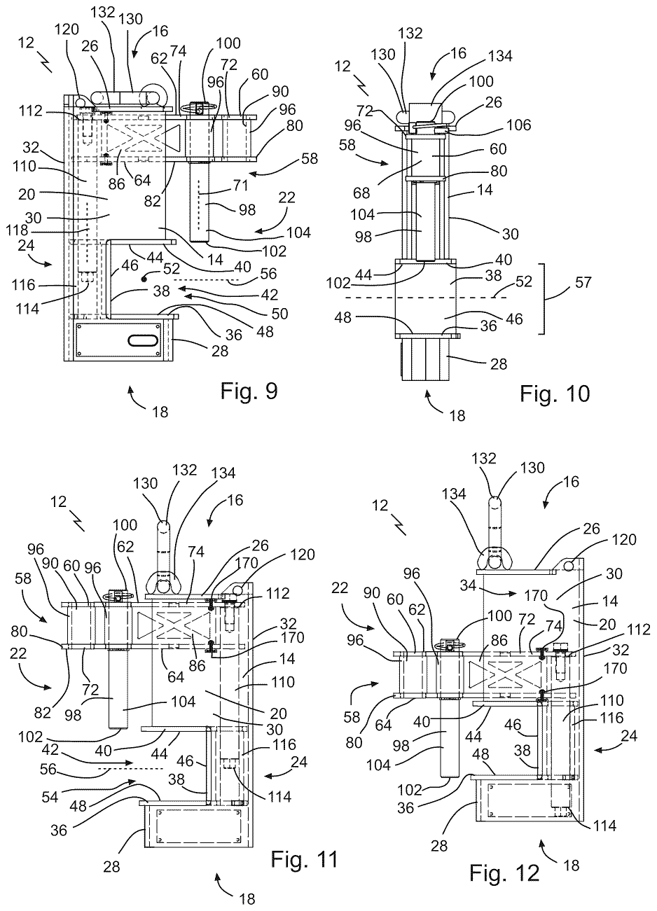

Referring to FIGS. 5, 6, 9, and 11-13, the structural body 14 and slide carriage 60 may be structured to accommodate the relative movement of one another. The structural body 14 may define one or more internal guide structures configured to guide the movement of the slide carriage 60. For example, slide post guides 119 may be provided to align and guide the slide post 110. The upper arm 74 may define a rear bolt receiving aperture 78 and the lower arm 80 may define a slide post aperture 84. A bolt 109 may be inserted through the rear bolt receiving aperture 78 to couple with the slide post 110. The slide post 110 may be inserted through the slide post aperture 84 to couple with the bolt 109. A lifting portion 138 of the release cable 136 may be secured to the slide carriage 60 at a cable connection point 88 that is below the cable guide 120, for example the point 88 may be aperture 78 if the top post 110 secures the cable. Thus, in the example shown, a lifting end of the release cable 136 is anchored to the cable connection point on the slide carriage. The rear slide post 110 may define a top 112, bottom 114, piston body 116, and may define an axis 118 of translation. The axis 118 may be parallel to an axis 71 of translation of the gate 98 (FIG. 9). The structural body 14 may be designed to enclose or partially enclose the slide carriage, providing protection from environmental factors and external forces. Optionally, end stops or damping elements may be positioned at the travel limits to absorb impact and reduce operational noise. The slide carriage and structural body may be constructed from materials such as aluminum, steel, or composite polymers, selected based on load capacity, durability, and frictional properties.

Slide mechanisms require precision engineering to ensure smooth, controlled motion and proper alignment. These systems may utilize linear guides, tracks, or channels that constrain the movement of sliding part while minimizing friction. Proper alignment may be achieved through accurately machined guide rails or sleeves that ensure the sliding part remains centered as it moves between apertures. Adjustable brackets or shims may be incorporated into fine-tune alignment and compensate for any manufacturing tolerances or structural shifts over time. Lubrication and wear-resistant materials, such as Teflon-coated surfaces or self-lubricating bearings may enhance durability and reduce friction-related issues. Referring to FIGS. 1-12 and 17-20, the gate mechanism 58 may be structured to move between a closed position to an open position. Downward movement of the slide post 110 may move the gate mechanism 58 to the closed position. Upward movement of the slide post 110 may move the gate mechanism 58 to the open position.

Referring to FIGS. 1-13, the frame 61 forming the arm 72 may comprise a suitable structure. The upper arm 74 and lower arm 80 may define one or more pin apertures 90. The apertures 90 may form a front aperture and a rear aperture as shown. The front aperture may define a suitable lateral width 92. The rear aperture may define a suitable lateral width 94. The apertures 90 may be structured to receive the gate 98. The gate 98 may pass through the aperture 90 of the upper arm 74, through guide shells 96 and through the aperture 90 of the lower arm 80. A top 100 of the gate 98 may extend past (above) a top surface 76 of the upper arm 74 and a base 102 of the gate may extend past (depend below) a base surface 82 of the lower arm 80. In use the gate 98 may be locked in the respective aperture or apertures 90. The gate 98 may lock via a rod 104, with a locking pin 106 passing through the rod 104 at or above the top surface 76 of the upper arm 74. The pin 106 may secure the rod 104 within the aperture 90. The pin 106 may comprise a pin bolt 108 that may prevent the pin 106 from being removed from the rod 104 during use. Referring to FIGS. 14-16, an alternate embodiment of the slide carriage 60 is disclosed. The slide carriage 60 may comprise a solid body 87 between the upper arm 72 and the lower arm 80. The solid body 87 may form the sides 66, front 68 and rear 70 of the slide carriage.

Referring to FIGS. 1-12 and 17-20, the lateral position of the gate 98 may be adjustable relative to the mouth 54, to modify a lateral width of the beam passage when the gate is closed. The slide carriage 60 may define a plurality of discrete gate mounting positions, for example apertures 90. The plurality of gate mounting positions may include one or more of a position that is structured to receive within the beam passage 42 a beam 154 of 3.5″ lateral width (i.e. a 2×4 board), a position that is structured to receive within the beam passage 42 a beam 154 of 5.5″ (i.e. a 2×6 board), and a position that is structured to receive within the beam passage 42 a beam 154 of 7.25″ (i.e. a 2×8 board). The plural positions may be defined by the one or more apertures 90, for example the rear and front apertures, respectively. Other positions and lateral widths may be used.

Referring to FIGS. 1-12 and 17-20, the wall hoist device 12 may incorporate mechanisms to one or more of hold the gate in the open or close position or both. In the example shown, the device 12 may incorporate one or more magnets 170 on the structural body or the gate, for example on the slide carriage as shown. The magnets 170 may one or more of hold the gate in an open position or a closed position. The mechanism, whether magnets or otherwise, would require that a predetermined release force be overcome to compel the gate to move out of the present position, thus preventing unintended early release, and retaining the gate in the open position after release. In the example shown, magnets 170 are provided on the top 62 and base 64 of the slide carriage 60. In other cases, magnets may be provided on the structural body. As shown, the slide carriage may be structured such that in the open and closed position, the magnets 170 are in close proximity with various metal parts of the structural body to achieve the desired magnetic attraction therebetween. Although magnets are shown in the embodiments, other mechanisms may be used to temporarily hold the carriage in the open and/or closed position, including latches, hooks, ratchets, spring pins, biasing devices, friction fits, and other mechanisms.

Referring to FIGS. 1, 2, 5 and 13-20, a release cable 136 may be provided with the wall hoist system 10, or the wall hoist may be structured otherwise to use a release cable in use. Various configurations may be employed to connect a cable to a structure to effect translational movement of the gate in response to cable actuation. In one embodiment, the cable is fixedly attached to the slide carriage via a mechanical fastener, such as a clamp, eyelet, or threaded connector, allowing direct force transfer upon cable tensioning. Alternatively, the cable may be routed around one or more pulleys or guide rollers mounted within the structural body, with the slide carriage coupled to an intermediate linkage or tensioning mechanism to facilitate controlled movement. In another configuration, the cable may engage a drive mechanism, such as a drum, capstan, or sprocket system, where rotational motion of the drive element translates into linear displacement of the slide carriage via a coupling interface, such as a ratchet or geared track. The cable may also be looped around an anchor point within the structural body, with opposing ends affixed to the slide carriage to enable bidirectional movement when the cable is pulled from either direction. In some embodiments, the cable may be tensioned by a biasing element, such as a spring or counterweight, to ensure consistent engagement and smooth operation. The connection points between the cable and the structure may incorporate damping elements, such as elastomeric bushings or shock absorbers, to minimize impact forces and wear. The cable may be constructed from flexible materials such as steel wire, synthetic fiber, or reinforced polymer, depending on the required tensile strength, durability, and environmental conditions.

Referring to FIGS. 1, 2, 5 and 13-20, the release cable 136 may be present in the end use of device 12, to move the gate mechanism 58 between the closed position and the open position. The release cable 136 may include a lifting portion 138 and a user portion 140, closer to a user end and an anchor end of the cable, respectively. The lifting portion 138 may be attached to the slide carriage 60, for example at the cable anchor point 88. A user may pull on the user portion 140, for example in a downward movement, in order to move the gate mechanism 58 to the open position, for example move the gate 98 up. The device 12 may comprise a cable guide 120. The cable guide 120 may be positioned on the structural body 14 to direct power transfer of the release cable to the gate, to permit the release cable 136 to reverse direction of the applied force. For example, if the release cable 136 is pulled in a downward direction, the cable guide 120 may translate that force to an upward direction, which may move the gate mechanism 58 to the open position. In other cases, this orientation may be modified or reversed, such as if a downward motion of the cable causes the gate to move downward to open the beam passage mouth. The cable guide 120 may be defined by a fixed pulley or bushing mounted on the structural body 14. The cable guide 120 may be defined at a mounting point 122 on the structural body 14. The cable guide 120 may include one or more eyelet 126 and a bushing surface 124 within the eyelet 126. The device 12 may comprise one or more cable eyelets 128 on an exterior surface of the structural body 14, for example the side wall 30, below the cable guide 120. The cable eyelets 128 may keep the release cable 136 aligned with the cable guide 120.

Lifts, such as cranes or telescopic handlers (telehandlers), may be used in both large-scale building projects and house construction, as they enable the efficient vertical and horizontal movement of heavy materials and equipment. Cranes, including smaller mobile cranes and tower cranes, may be used to lift materials like steel beams, framed walls, roofing trusses, and precast concrete components to higher elevations. These cranes may be equipped with hoists, pulleys, and hook systems to ensure precise and controlled lifting, which is particularly important in residential projects with limited space. A telescopic handler, also called a lull, telehandler, teleporter, reach forklift, or zoom boom, is a machine widely used in agriculture and industry. It is somewhat like a forklift but has a boom (telescopic cylinder), making it more a crane than a forklift, with the increased versatility of a single telescopic boom that can extend forwards and upwards from the vehicle. The boom can be fitted with different attachments, such as a bucket, pallet forks, muck grab, or winch.

Referring to FIGS. 1-12 and 17-20, the device 12 may comprise a lift connector 130 on the structural body 14. For example, the lift connector 130 may be attached to the structural body one or more of the top plate 26, side walls 30, or rear wall 32. The lift connector 130 may comprise a lifting lug 132 or other suitable type of hook or connection for a crane cable. The lifting lug 132 may be attached to the structural body 14 via a suitable mechanism, for example a mount 134 or a direct attachment method such as welding. Lifting of the wall hoist system 10 may be carried out using a crane 142 that is connected to the wall hoist device 12. The mount 134 may allow for the rotation of the lifting lug, which may be desirable when the device 12 is lifted by a crane 142 or other lift. A crane hook 146 may attach to the lifting lug 132 of the device 12, and the hook 146 may be attached to the crane 142 via a cable 144.

Referring to FIGS. 17-20, a suitable method may be carried out to lift a wall frame 148 using the wall hoist system 10. In a first step, the system 10 may be placed underneath the wall frame 148, to hook the top plate or other suitable beam of the wall frame (FIG. 17). The beam 154 of the wall frame 148 may pass through the mouth 54 and into the beam passage 42. The beam 154 may be secured within the beam passage 42. Securing may further comprise translating the gate 98 across the mouth 54 by moving the gate mechanism 58 into the closed position (FIG. 18). In a subsequent step, the crane hook 146 may be attached to the lifting lug 132. In a subsequent step, the crane 142 may be used to lift the system 10 (FIG. 19), which in turn may move the wall frame 148 into an upright, for example vertical, position. The wall frame 148 may be anchored to a building structure or ground surface, such as platform 168, while the wall frame 148 is in the vertical position and prior to releasing the wall hoist device 12 from the wall frame 148, for example using fasteners, braces, or other structural connection mechanisms or methods. In a subsequent step, a user may release the wall hoist from the wall frame, for example the user may achieve such goal by pulling on the user portion 140 of the release cable 136. The lifting portion 138 of the release cable 136 may pull upwards on the slide carriage 60 of the gate mechanism 58, while the user pulls downward, to raise the gate mechanism 58 by translation into the open position. Once the gate mechanism 58 is in the open position, the system 10 may be removed from the beam 154 of the wall frame 148.

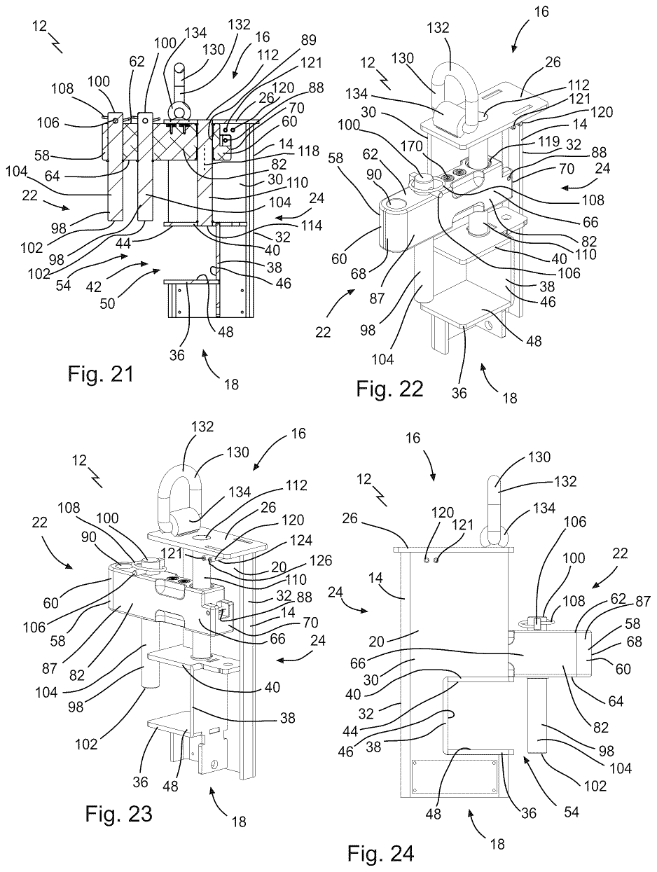

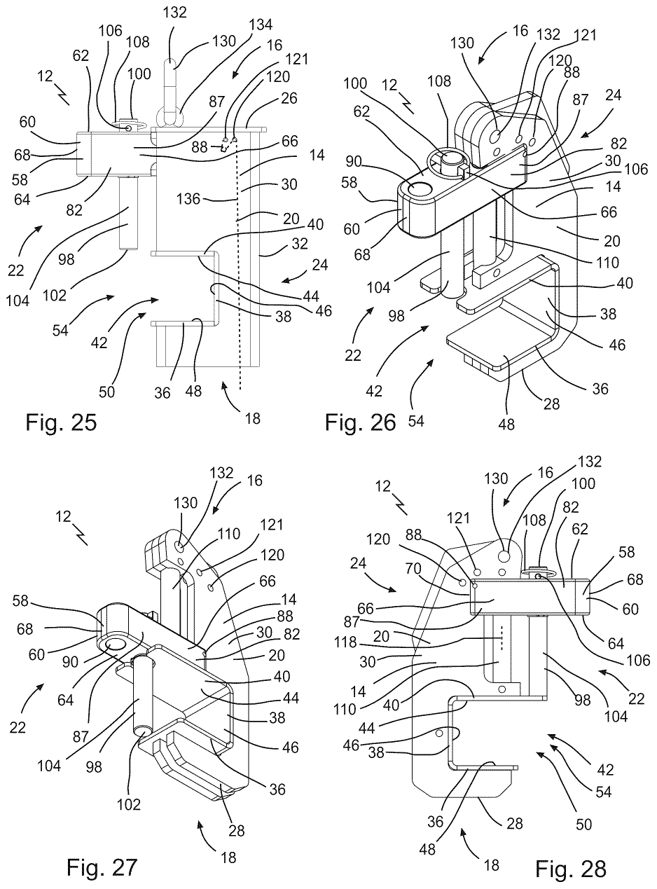

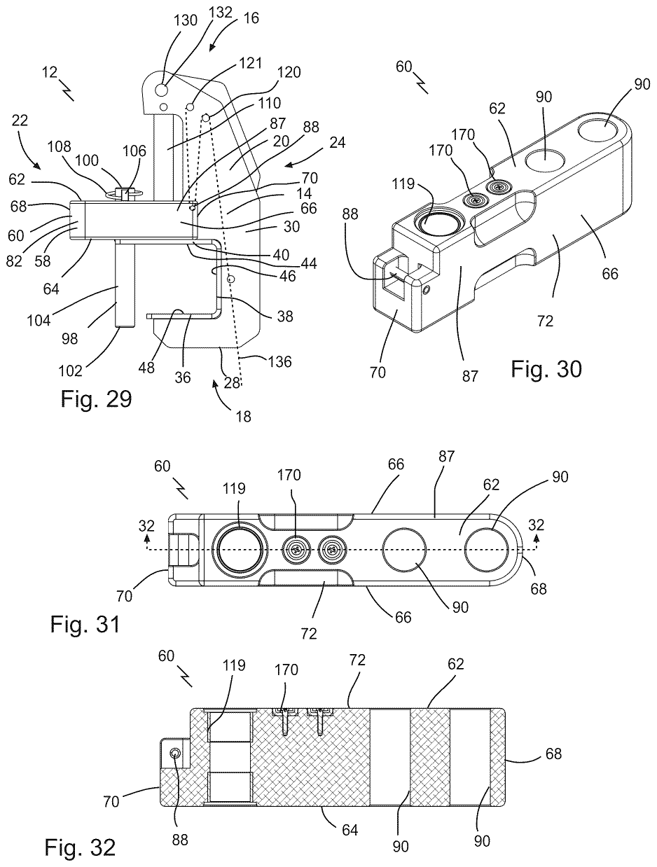

Referring to FIGS. 21-25, and 26-32, two more embodiments of a wall hoist device 12 are disclosed. In the examples shown, a rear portion of the slide carriage 60 defines a slide post guide 119, while the structural body defines the slide post 110. Thus, the slide carriage 60 may be structured to move independently of the slide post 110, up and down the post 110. The slide post 110 may thus be considered stationary, and the guide 119 moving. The slide carriage 60 may be attached to the slide post 110 via a rear aperture 89. The slide carriage 60 may move along the stationary slide post 110 to move the gate mechanism 58 from the open position to the closed position.

Referring to FIGS. 21-25, and 26-32, the structural body and slide carriage may be structured to achieve a force advantage from pulling action on the release cable 136. One way to achieve this is to form the cable connection point 88 on the slide carriage as a cable guide, so that it functions as a moving pulley or bushing, while anchoring the release cable 136 to a cable anchor point 121 on the structural body above the point 88. In this way, the slide carriage acts similar to a block and tackle, doubling the effect of power transfer to the slide carriage from pulley force on the release cable. A moving pulley is a type of pulley system where the pulley itself is attached to the load and moves along with it, unlike a fixed pulley that remains stationary. This configuration provides a mechanical advantage (MA) greater than 1, effectively reducing the input force required to lift a load. The force advantage in the case of a two-part pulley as shown is calculated using the formula MA=2, meaning the effort force required is halved compared to lifting the load directly. Moving pulleys are commonly used in block and tackle systems, which combine multiple pulleys to further increase mechanical advantage. Key technical terms associated with moving pulleys include tension force, which is the force transmitted through the rope or cable; effort force, which is the force applied by the user or motor; and load force, which is the weight of the object being lifted. Industrial applications often refer to these systems as hoisting mechanisms or lifting assemblies, widely utilized in cranes, elevators, and material handling equipment. The efficiency of a moving pulley system depends on factors such as frictional losses, rope stiffness, and pulley bearing efficiency, which engineers consider when designing lifting solutions. In the examples shown, the release cable may extend through an interior of the structural body, for example via an open base 18 of the body 14, to the cable guide 120.

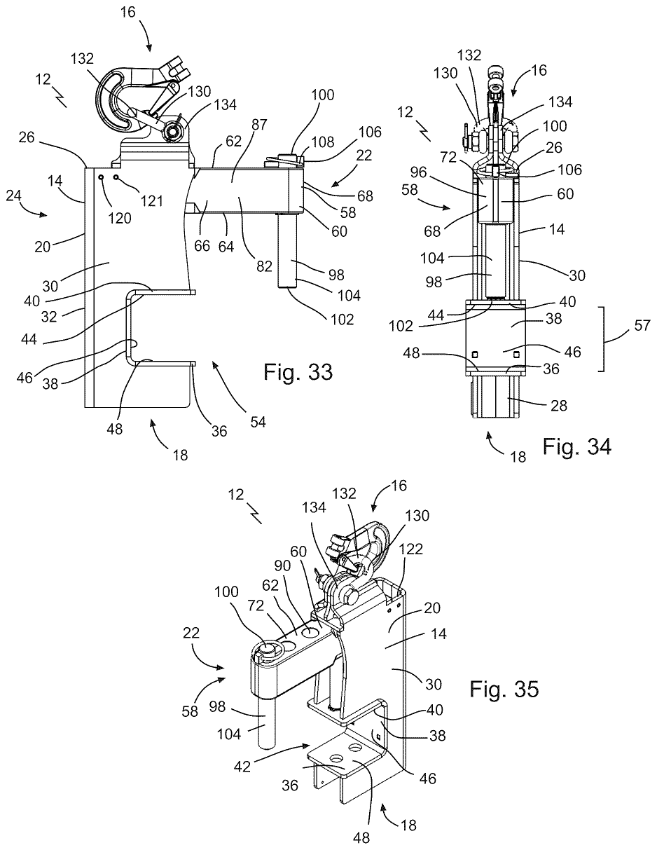

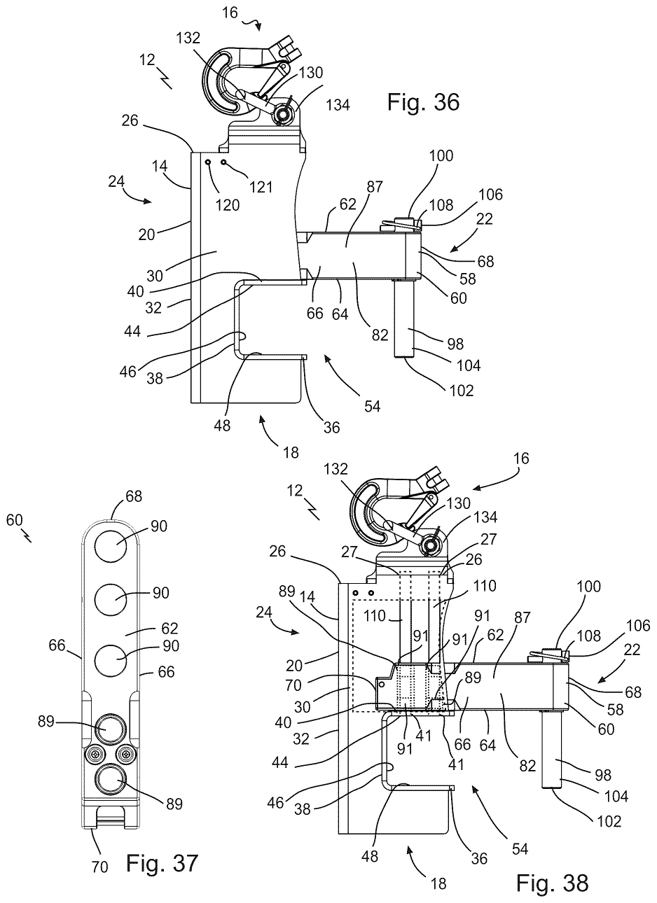

Referring to FIGS. 33-38, another embodiment of the wall hoist device 12 is disclosed. The wall hoist device 12 comprises a structural body 14, which may have a top 16, a base 18, sides 20 and a front 22. The wall hoist device 12 comprises a gate 98, which may be mounted to translate, for example slide up and down, relative to the structural body 14 to open and close the mouth 54 (move the gate between open and closed positions). The gate 98 may extend from a slide carriage 60 that is mounted to translate at least partially within the structural body 14. The slide carriage 60 assembly may be mounted for translational movement within the structural body 14. The structural body 14 and slide carriage 60 may be structured to accommodate the relative movement of one another in the unique fashion illustrated in this embodiment. Referring to FIG. 38, the structural body 14 may define one or more internal guide structures configured to guide the movement of the slide carriage 60. For example, two or more fixed parallel slide posts 110 may be provided to align and guide slide carriage 60. Other plural or singular slide structures may be provided. The slide carriage 60 may define two corresponding parallel rear apertures 89. The slide posts 110 may be inserted through the slide post apertures 89. One or more bushings 91 or other guide structures may be positioned in the apertures 89 or on the posts 110 to facilitate relative sliding movement. The posts 110 may be positioned in parallel as shown in a suitable fashion, for example by alignment in apertures 27 and 41 on the top plate 26 and overhead cantilever 40, or other structure. The embodiment provides an example where the slide carriage 60 may be structured to move independently of the slide posts 110, up and down the posts 110. The slide posts 110 may thus be considered stationary or fixed during operation, although in other cases the slide structure may move relative to the body 14. The slide carriage 60 may move along the stationary slide posts 110 to move the gate mechanism 58 from the open position to the closed position. Referring to FIG. 37, the lateral position of the gate 98 may be adjustable relative to the mouth 54, to modify a lateral width of the beam passage when the gate is closed. The slide carriage 60 may define a plurality of discrete gate mounting positions, for example three or more apertures 90. The plural positions may be defined by the one or more apertures 90, for example the rear, middle, and front apertures, respectively. Other positions, numbers of apertures, and lateral widths may be used.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

1. A wall hoist system comprising:
a structural body that defines a beam passage that opens laterally to define a mouth;
a gate mounted to translate relative to the structural body to open and close the mouth; and
a release cable that is connected to open the gate when the release cable is pulled downward from a position below the structural body in use.

2. The wall hoist system of claim 1 further comprising a lift connector on the structural body.

3. The wall hoist system of claim 1 further comprising a cable guide positioned on the structural body to redirect the release cable to the gate.

4. The wall hoist system of claim 3 in which the cable guide is defined by a fixed pulley or bushing mounted on the structural body.

5. The wall hoist system of claim 3 in which the gate extends from a slide carriage that is mounted to translate within the structural body.

6. The wall hoist system of claim 5 in which a portion of the release cable engages the slide carriage at a cable connection point that is below the cable guide.

7. The wall hoist system of claim 6 in which a lifting end of the release cable is anchored to the cable connection point on the slide carriage.

8. The wall hoist system of claim 6 in which the cable connection point forms a second cable guide that defines a moving pulley or bushing that redirects the release cable to a cable anchor point on the structural frame.

9. The wall hoist system of claim 5 in which:
a rear portion of the slide carriage comprises a slide post or a slide post guide; and
the structural body comprises the other of the slide post or slide post guide to align and guide the slide carriage along a translation axis within the structural body.

10. The wall hoist system of claim 5 in which the lateral position of the gate is adjustable, relative to the mouth, to modify a lateral width of the beam passage when the gate is closed.

11. The wall hoist system of claim 10 in which the slide carriage defines a plurality of discrete gate mounting positions.

12. The wall hoist system of claim 11 in which the plurality of gate mounting positions include one or more of:
a position that is structured to receive within the beam passage a beam of 3.5″ lateral width;
a position that is structured to receive within the beam passage a beam of 5.5″ lateral width; and
a position that is structured to receive within the beam passage a beam of 7.25″ lateral width.

13. The wall hoist system of claim 9 in which the release cable extends:
through an interior of the structural body, via an open base of the structural body, to the cable guide; or
along an exterior surface of the structural body, through one or more cable eyelets on the exterior surface of the structural body, to the cable guide.

14. The wall hoist system of claim 1 in which the gate is mounted to translate up to open the mouth when the release cable is pulled downward, in use.

15. The wall hoist system of claim 1 in the beam passage is defined by a beam support shelf, an upright riser, and an overhead cantilever.

16. The wall hoist system of claim 1 in which the gate comprises a removable pin.

17. The wall hoist system of claim 1 further comprising one or more magnets on the structural body or the gate to one or more of hold the gate in:
an open position; or
a closed position.

18. A method comprising:
securing a wall hoist to a beam of a wall frame by inserting the beam through a mouth, and into a beam passage, of the wall hoist and securing the beam from exit from the mouth by translating a gate into a closed position;
lifting the wall hoist to erect the wall frame into an upright position; and
releasing the wall hoist from the wall frame by pulling on a release cable to translate the gate into an open position.

19. The method of claim 18 further comprising anchoring the wall frame to a building structure or ground surface while the wall frame is in the upright position and prior to releasing the wall hoist from the wall frame.

20. The method of claim 18 in which securing further comprises translating the gate across the mouth.

21. The method of claim 18 in which lifting is carried out using a crane or telehandler that is connected to the wall hoist.
